(19) United States
(12) Patent Application Publication
(10) Pub. No.: US 2008/0030025 A1
(43) Pub. Date: Feb. 7, 2008

(54) MALE COUPLING FOR CONNECTING TO FEMALE THREADED COUPLING

(75) Inventors: Todd J. Vogel, Waterville, OH (US); Ryan J. Williams, Sylvania, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(73) Assignee: Eaton Corporation, Cleveland, OH (US)

(21) Appl. No.: 11/833,712

(22) Filed: Aug. 3, 2007

Related U.S. Application Data
(60) Provisional application No. 60/821,317, filed on Aug. 3, 2006.

(51) Int. Cl. F16L 37/00

(52) U.S. Cl. 285/308

(57) ABSTRACT

A coupling assembly including first and second members arrangeable between uncoupled and coupled positions. The first member has a receiving portion sized to receive at least a portion of the second member and internal threads provided therein. The second member has an exterior surface. A ratcheting locking member is disposed about the exterior surface of the second member and configured to move between locking and releasing positions. The ratcheting locking member is also biased to the locking position and has a retaining formation configured to mesh with and engage the internal threads of the first member. Upon insertion of the second member into the first member, the retaining formation of the ratcheting locking member progressively engages the internal threads of the first member, thereby locking the first and second members together.

### CROSS-REFERENCE TO RELATED APPLICATION

This application claims priority to U.S. Provisional Application No. 60/821,317 filed on Aug. 3, 2006, the disclosure of which is hereby incorporated by reference in its entirety herein.

### BACKGROUND

1. Field of the Invention

The present application relates to fluid couplings and, more particularly, to fluid couplings that are configured to connect to a female threaded coupling.

2. Description of the Related Art

Coupling assemblies for the transmission of gases or fluids that may be secured together by axial movement of a male coupling into a female coupling are known in the art. In a typical application, a male coupling and a female coupling function as an adapter between a flexible conduit, such as a hose, and an apparatus, such as a pump. While several methods are commonly used to connect the male coupling to the flexible conduit, such as a barbed hose adapter, the female coupling is typically connected to a standard female threaded port in the apparatus.

Manufacturers of coupling assemblies have attempted to reduce complexity and cost by integrating the female coupling directly into their customer's apparatus (known as “direct porting”), thereby eliminating the need for the standard female threaded port. However, customers are oftentimes reluctant to integrate a particular coupling manufacturer's female coupling directly into their apparatus because doing so would make it difficult to convert back to a standard female threaded port. Additionally, customers may be reluctant to integrate a particular manufacturer's female coupling directly into the apparatus because doing so would require them to purchase all their replacement hoses from the coupling manufacturer. There are continual efforts to improve upon the current designs of coupling assemblies, particularly to reduce the complexity and cost of coupling assemblies as well as to design couplings that are compatible with standard fittings (e.g., a standard female threaded port).

### SUMMARY

A coupling assembly is disclosed that includes first and second members arrangeable between uncoupled and coupled positions. The first member has a receiving portion sized to receive at least a portion of the second member and internal threads provided therein. The second member has an exterior surface. A ratcheting locking member is disposed about the exterior surface of the second member and configured to move between locking and releasing positions. The ratcheting locking member is also biased to the locking position and has a retaining formation configured to mesh with and engage the internal threads of the first member. Upon insertion of the second member into the first member, the retaining formation of the ratcheting locking member progressively engages the internal threads of the first member, thereby locking the first and second members together.

A male coupling is disclosed for connecting to a female threaded port having a receiving portion provided with internal threads. The male coupling includes a body having a leading portion, a trailing portion, and an exterior surface. The leading portion is sized to be received by the receiving portion of the female threaded portion. The male coupling also includes a number of locking member segments disposed about the body and configured to pivot between locking and releasing positions, where each locking member segment has a retaining formation configured to mesh with and engage the internal threads of the female threaded port. The male coupling further includes a resilient biasing element configured to bias each locking member segment to its locking position. Upon insertion of the male coupling into the female threaded port, the retaining formation of each locking member segment progressively engages the internal threads of the female threaded port, thereby locking the male coupling and the female threaded port together.

### BRIEF DESCRIPTION OF THE DRAWINGS

It will be appreciated that the illustrated boundaries of elements in the drawings represent one example of the boundaries. One of ordinary skill in the art will appreciate that a single element may be designed as multiple elements or that multiple elements may be designed as a single element. An element shown as an internal feature may be implemented as an external feature and vice versa.

Further, in the accompanying drawings and description that follow, like parts are indicated throughout the drawings and description with the same reference numerals, respectively. The drawings may not be drawn to scale and the proportions of certain elements have been exaggerated for convenience of illustration.

FIGS. 1A and 1B illustrate cross-sectional views of one embodiment of a coupling assembly 10 in its uncoupled and coupled positions, respectively.

FIGS. 2A-2D illustrate cross-sectional views of the coupling assembly 10 at various stages during the coupling operation.

FIGS. 3A-3C illustrate cross-sectional views of the coupling assembly 10 at various stages during the uncoupling operation.

FIG. 4A illustrates a perspective view of one embodiment of a male coupling member 400 configured to connect to a female threaded coupling 402.

FIG. 4B illustrates a cross-sectional view of the male coupling 400 configured to connect to a female threaded coupling 402, where the male coupling 400 and the female threaded coupling 402 are shown in their uncoupled position.

FIG. 4C illustrates a cross-sectional view of the male coupling 400 and the female threaded coupling 402 in the coupled position.

FIGS. 5A-5D illustrate cross-sectional views of portions of the male coupling 400 and the female threaded coupling 402 at various stages during the coupling operation.

FIGS. 6A-6C illustrate cross-sectional views of portions of the male coupling 400 and the female threaded coupling 402 at various stages during the uncoupling operation.

FIG. 7 illustrates a cross-sectional view of a portion of another embodiment of a coupling assembly 700 in its coupled position.

### DETAILED DESCRIPTION

Certain terminology will be used in the following description for convenience in reference only and will not be limiting. The terms “forward” and “rearward” with respect to each component of the coupling assembly will refer to directions towards and away from, respectively, the coupling direction. The terms “rightward” and “leftward” will refer to directions in the drawings in connection with which the terminology is used. The terms “inwardly” and “outwardly” will refer to directions toward and away from, respectively, the geometric centerline or longitudinal axis of the coupling assembly. The terms “upward” and “downward” will refer to directions as taken in the drawings in connection with which the terminology is used. All of the foregoing terms include the normal derivative and equivalents thereof.

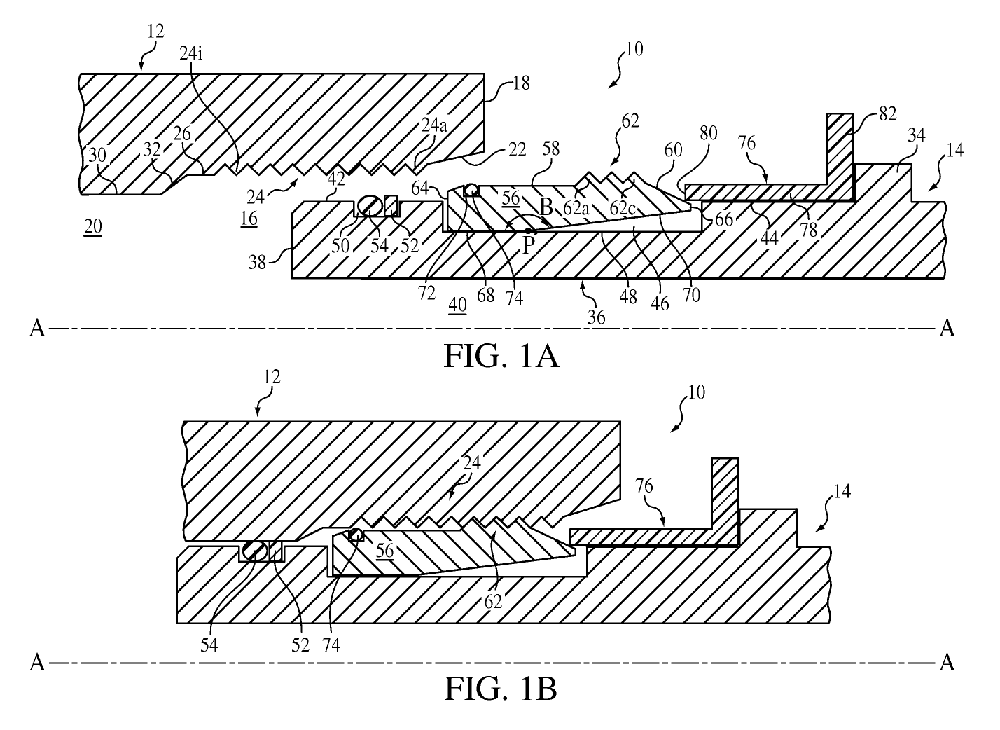

Illustrated in FIGS. 1A and 1B are cross-sectional views of one embodiment of a coupling assembly 10 shown in the uncoupled and coupled positions, respectively. The coupling assembly 10 includes a first member 12 and a second member 14 that, together, operate as a push-to-connect type coupling assembly, which will be discussed in further detail below. The first member 12 generally functions as the “female” member of the coupling assembly 10 and the second member 14 generally functions as the “male” member of the coupling assembly 10, such that the first member 12 is configured to receive the second member 14. Both the first and second members 12, 14 share the same central longitudinal axis A when they are in the coupled position as shown in FIG. 1B. In one embodiment, the first and second members 12, 14 can be formed of carbon steel. In alternative embodiments, the first and second members 12, 14 can be formed of other materials, such as brass, aluminum, stainless steel, and plastic.

In the illustrated embodiment, the first member 12 is a female threaded coupling, such as a female threaded port that includes a receiving portion 16 having a receiving end 18, a remote portion (not shown) having a remote end (not shown), and a passageway 20 extending between the receiving end 18 and the remote end that permits fluid to flow therethrough. The remote portion of the first member 12 is provided with external threads for attachment to internal threads of a separate component (not shown). Alternatively, the female threaded port can be integrated directly into an apparatus, such as a pump, manifold, etc. In an alternative embodiment (not shown), the first member 12 can include other suitable connection means for attachment to a separate component (not shown).

With continued reference to FIGS. 1A and 1B, the first member 12 includes a first chamfered surface 22 that extends rearward and inward from the receiving end 18. A set of internal threads 24 extends rearward from the first chamfered surface 22 and a first interior cylindrical surface 26 extends rearward from the internal threads 24a-i. In the illustrated embodiment, the internal threads 24 have a triangular-shaped profile when viewed in cross-section and include nine threads 24a-i. In alternative embodiments (not shown), the internal threads 24 can take the form of other profiles (e.g., trapezoidal, square, or rectangular) when viewed in cross-section and include any number of threads. In another alternative embodiment (not shown), the first member 12 may not include the first chamfered surface 22.

The remote portion of the first member 12 includes a second interior cylindrical surface 30 having an inner diameter that is smaller than the first interior surface 26. Extending forward and outward from the second interior surface 30 is a tapered surface 32 that meets the first interior surface 26.

As shown in FIGS. 1A and 1B, the second member 14 includes a collar 34 that separates a leading portion 36 having a leading end 38 from a trailing portion (not shown) having a trailing end (not shown). Extending through the second member 14 from the leading end 38 to the trailing end (not shown) is a passageway 40 that permits fluid to flow therethrough. In one embodiment (not shown), the trailing portion of the second member 14 can be connected to a hose nipple for receiving a hose. In alternative embodiments (not shown), the trailing portion may be provided with external threads for attachment to internal threads of another component or may be counter-bored for receiving a tube that can be brazed to the second member 14.

The leading portion 36 of the second member 14 includes a first exterior cylindrical surface 42 and a second exterior cylindrical surface 44 separated from each other by a first outwardly facing annular groove 46 that extends radially inward from the first and second exterior surfaces 42, 44. The first groove 46 is at least partially defined by a third exterior cylindrical surface 48.

In the illustrated embodiment, the first and second exterior surfaces 42, 44 have the same outer diameter that is sized to be received by the second interior surface 30 of the first member 12. In alternative embodiments (not shown), the first and second exterior surfaces 42, 44 may have different diameters so long as the first exterior surface 42 has an outer diameter that is sized to be received by the second interior surface 30 of the first member 12.

The first exterior surface 42 of the second member 14 includes a second outwardly facing annular groove 50 extending radially inward therefrom. Positioned within the second groove 50 are a support ring 52 constructed of a rigid material, such as plastic, leather, or hard rubber, and an annular seal 54 constructed of a suitable sealing material, such as neoprene or another elastomeric material. The annular seal 54 is positioned in the second groove 50 between the support ring 52 and the leading end 38 of the second member 14. The annular seal 54 is sized for receipt by and to sealingly engage the second interior surface 30 of the first member 12. The support ring 52 is sized for receipt by the second interior surface 30 of the first member 12 and serves to protect the annular seal 54 from damage when the coupling assembly 10 is used in high-pressure applications. In another embodiment (not shown), the support ring 52 may be eliminated when the coupling assembly is used in low-pressure applications. In another alternative embodiment (not shown), the annular seal and the support ring may be received in a groove in the second interior surface 30 of the first member 12 and sized to sealingly engage the first exterior surface 42 of the second member 14.

The coupling assembly 10 also includes a ratcheting locking member configured to lock the first and second members 12, 14 together. In the illustrated embodiment, the ratcheting locking member is in the form of separate ratcheting, locking member segments 56 that are positioned within the first groove 46 of the second member 14 and, together, form the ratcheting locking member. In one embodiment, the ratcheting locking member includes four locking member segments 56. In alternative embodiments, the ratcheting locking member can include a different number of locking member segments.

As shown in FIGS. 1A and 1B, each locking member segment 56 includes an exterior cylindrical surface 58 and an exterior tapered surface 60 that are separated from each other by a retaining formation that is configured to mesh with and engage the internal threads 24 of the of the first member 12 when the second member 14 is inserted into the first member 12, which is discussed in further detail below. In the illustrated embodiment, the retaining formation includes an external partial threaded formation 62 that projects outward from the groove 46 beyond the first exterior surface 42 of the second member 14. The threaded formation 62 is characterized as being “partial” due to the fact that the ratcheting locking member is comprised of locking member segments 56. Hence, the partial threaded formation 62 of each locking member segment 56 comprises only a portion of a threaded formation. However, it will be appreciated that the locking member segments 56, together, form a threaded formation, although the threads may not be continuous since adjacent locking member segments 56 will have a small space in between them.

In the illustrated embodiment, the partial threaded formation 62 includes three triangular-shaped threads 62a-c when viewed in cross-section. However, in alternative embodiments (not shown), the partial threaded formation 62 can include a different number of threads and/or the threads can take the form of other shapes when viewed in cross-section (e.g., square, rectangular, or trapezoidal), so long as they are capable of meshing with and engaging the internal threads 24 of the first member 12. Additionally, in alternative embodiments (not shown), the retaining formation can include a plurality of discrete radially outward extending projections or protrusions that are capable of engaging the internal threads 24 of the first member 12. In these embodiments, the plurality of discrete radially outward extending projections or protrusions can take the form of any shape and can be arranged in any pattern, so long as they are capable of engaging the internal threads 24 of the first member 12.

In the illustrated embodiment, each locking member segment 56 also includes a forward end 64, a rearward end 66, and first and second interior surfaces 68, 70. As shown in FIGS. 1A and 1B, the first and second interior surfaces 68, 70 are oriented at an angle B relative to each other, such that an edge is formed between the first interior surface 68 and the second interior surface 70. This edge defines a pivot axis P (extending out of the drawing) about which each locking member segment 56 pivots. The pivot axis P of each locking member segment 56 is spaced from and oriented perpendicular to the longitudinal axis A of the coupling assembly 10.

Due to the edge that defines pivot axis P, each locking member segment 56 is capable of pivoting between a first position (i.e., a locking position) and a second position (i.e., a releasing position). In the locking position, the first interior surface 68 abuts against the third exterior surface 48 of the second member 14 as shown in FIGS. 1A and 1B. In the releasing position, the locking member segment 56 is pivoted about the pivot axis P in the clockwise direction, such that the second interior surface 70 abuts against the third exterior surface 48 of the second member 14 (not shown). It will be appreciated, however, that the releasing position does not necessarily require that the second interior surface 70 of each locking member segment 56 abut against the third exterior surface 48 of the second member 14. Instead, each locking member segment 56 need only pivot in the clockwise direction a sufficient amount to provide clearance between the outer extremities of the partial threaded formation 62 of the locking member segments 56 and the inner extremities of the internal threads 24 of the first member 12.

Provided adjacent to the forward end 64 of each locking member segment 56 is an outwardly facing groove 72 extending radially inward from the exterior surface 58 of each locking member segment 56. Together, the grooves 72 in the locking member segments 56 form an annular groove configured to receive an annular resilient, biasing element 74. The biasing element 74, which wraps around all of the locking element segments 56, is configured to bias the locking member segments 56 to their locking positions and due to its resiliency, is capable of: i) expanding radially outwardly when the locking member segments 56 are moved to their releasing positions ii) returning the locking member segments 56 to their locking positions without the need of additional force. In the illustrated embodiment, the biasing element 74 is an O-ring. In alternative embodiments, the biasing element 74 can be a garter spring, split retaining ring, or an elastomeric or plastic ring.

In an alternative embodiment (not shown), the locking member segments 56 may be rotated 180° and positioned within the first groove 46 such that the retaining formation of the each locking member segment is located closer to the leading end 38 of the second member 14. In this embodiment, the biasing element would be provided in outwardly facing grooves in the locking member segments 56 adjacent the rearward end of the locking member segments 56.

The coupling assembly 10 also includes a release sleeve 76 provided between the locking member segments 56 and the collar 34. The release sleeve 76 includes a sleeve portion 78 having a forward end 80 and a flange portion 82 that extends radially outward from the sleeve portion 78. The sleeve portion 78 of the release sleeve 76 overlaps a portion of the first groove 46 and a portion of the locking member segments 56. Thus, the locking member segments 56 are retained in the first groove 46 on one side by the biasing element 74 and on the other side by the sleeve portion 78 of the release sleeve 76. In the illustrated embodiment, the release sleeve 76 has a generally L-shaped profile when viewed in cross-section. In alternative embodiments (not shown), the locking sleeve may take the form of other profiles when viewed in cross-section.

The release sleeve 76 is seated on the second exterior surface 44 of the body in an axially movable arrangement, such that the release sleeve 76 is movable between rearward and forward positions. Axial travel of the release sleeve 76 is limited in the rearward direction by the collar 34 and in the forward direction by the furthest rearward partial thread 62c of each locking member segment 56. The release sleeve 76 is in its rearward position as shown in FIGS. 1A and 1B.

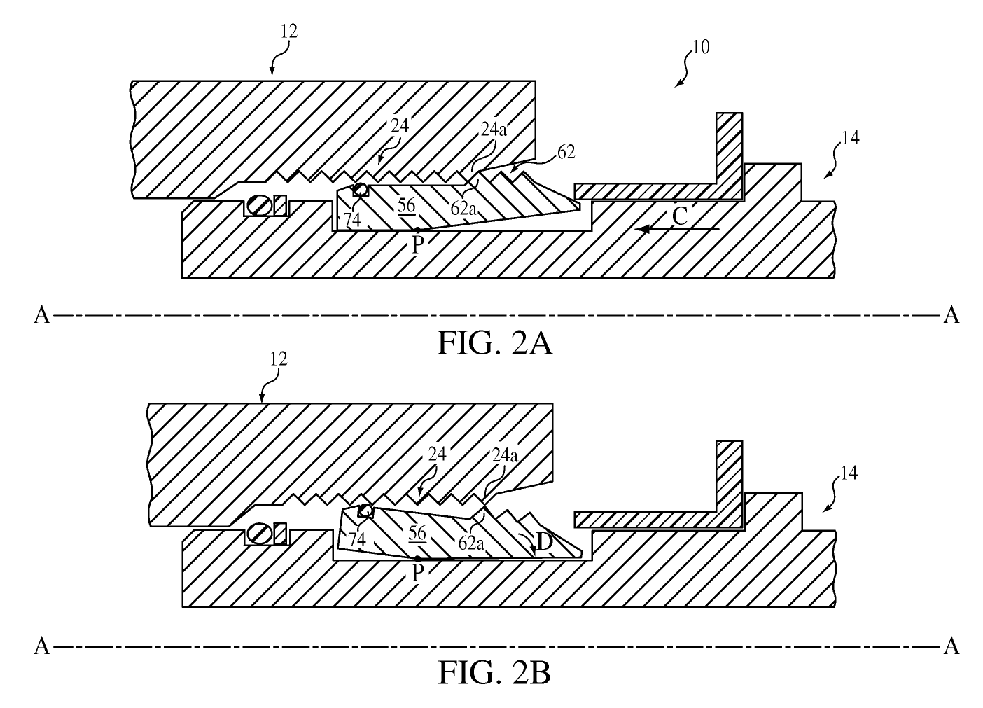

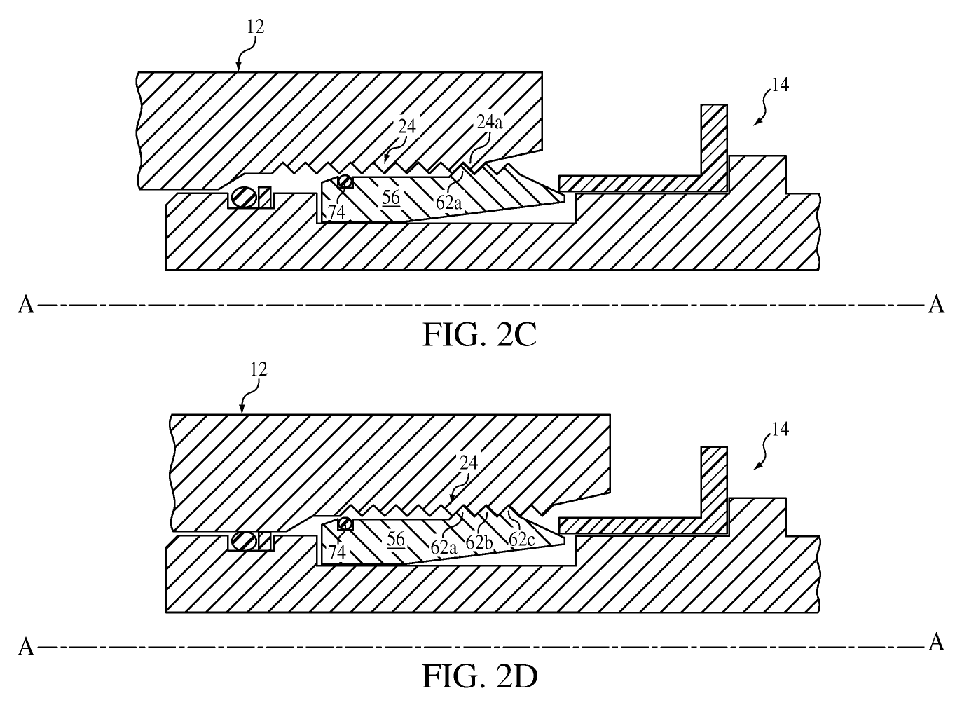

To couple the first and second members 12, 14 together, the second member 14 is moved forward (in the direction of arrow C) into the first member 12 until the forward most thread 62a of the partial threaded formation 62 of each locking member segment 56 engages the forward most internal thread 24a of the first member 12 (FIG. 2A). Upon continued forward movement of the second member 14, the thread 24a of the first member 12 interacts with and forces the locking member segments 56 to pivot clockwise (in the direction of arrow D) about the pivot axis P against the urging of the biasing element 74, thereby causing the biasing element 74 to expand radially outward (FIG. 2B). The locking member segments 56 pivot clockwise about the pivot axis P until they cam or “ratchet” over the apex of the first thread 24a. As soon as this occurs, the locking member segments 56 return or “spring back” to their locking position due to the resiliency of the biasing element 74, such that the forward most partial thread 62a of the partial thread formation 62 meshes with and engages the forward most thread 24a of the first member 12 (FIG. 2C).

Upon further forward movement of the second member 14 into the first member 12, the partial threaded formation 62 of each locking member segment 56 cams or “ratchets” along the internal threads 24 of the first member 12, by alternating between locking and releasing positions, to progressively mesh with and engage additional internal threads 24 of the first member 12 (i.e., the coupled position of the coupling assembly 10) (FIG. 2D). In this position, the engagement of the partial threaded formation 62 of the locking member segments 56 to the internal threads 24 of the first member 12 prevents the withdrawal of the second member 14 from the first member 12. When the first and second members 12, 14 are in the coupled position (FIG. 2D), the annular seal 54 on the second member 14 is sealingly engaged to the second interior surface 30 of the first member 12, thereby preventing fluid leakage.

Since the second member 14 is capable of connecting to a female threaded coupling (e.g., the first member 12), a female adapter can be eliminated reducing cost as well as a leak path. Additionally, customers would no longer be required to purchase all of their replacement hoses from the manufacturer of the coupling assembly.

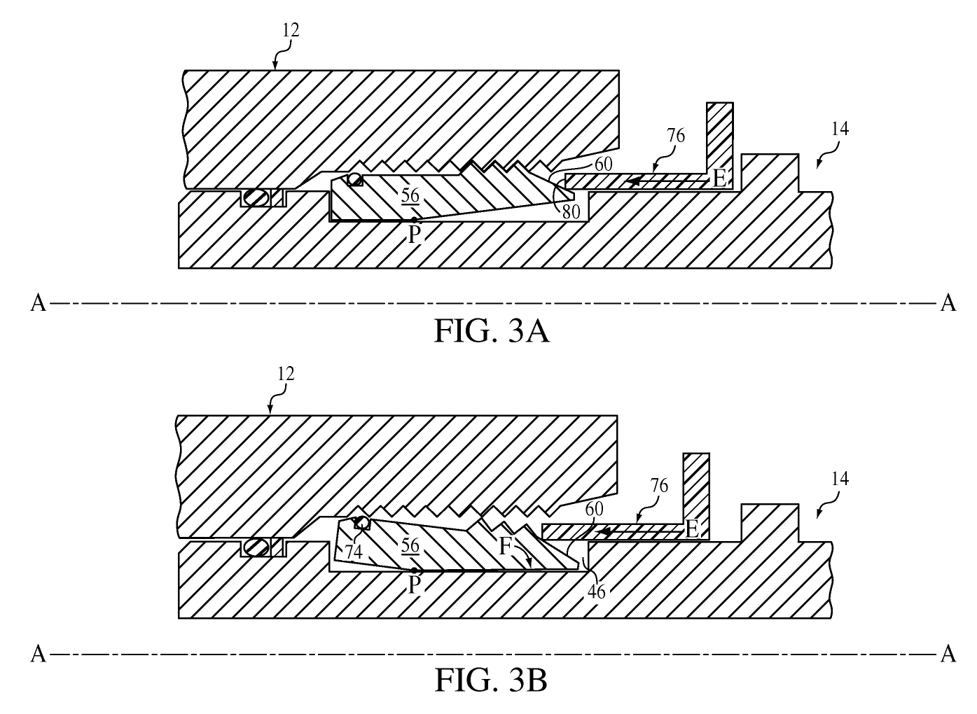

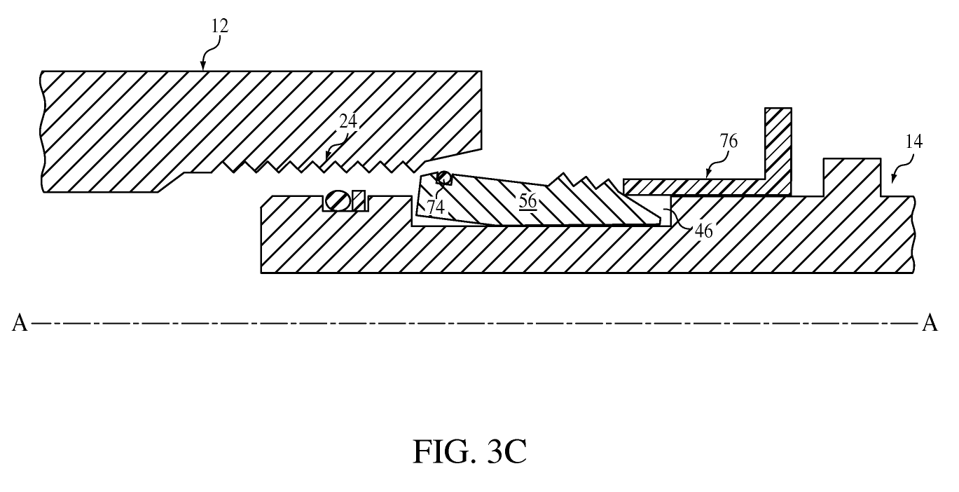

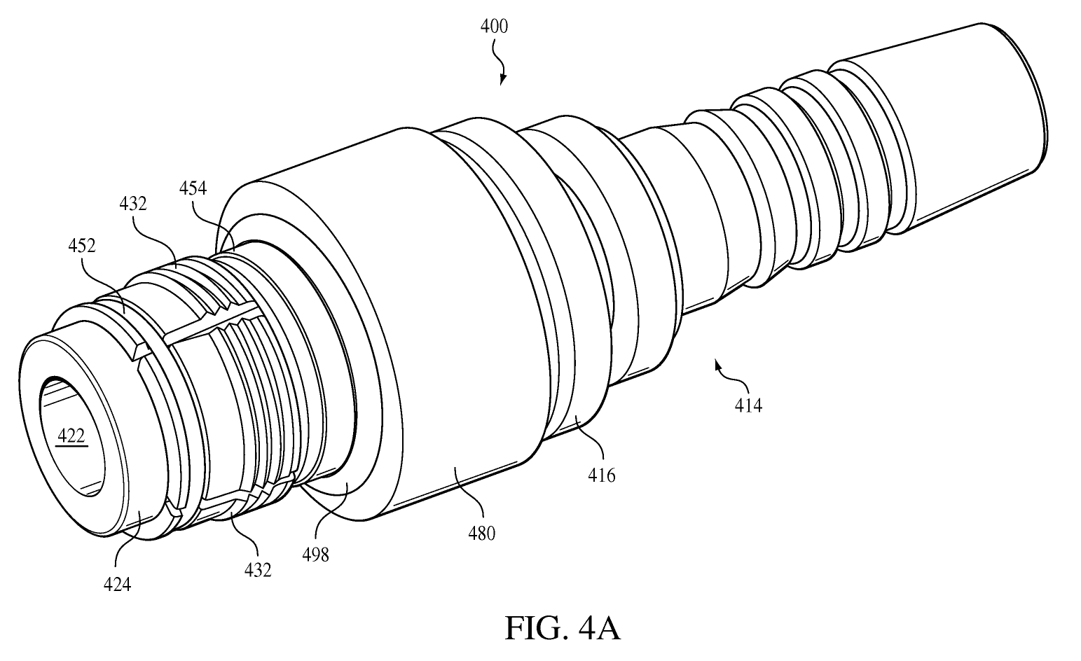

When it is desired to uncouple the second member 14 from the first member 12, the release sleeve 76 is moved forward (in the direction of arrow E) from its rearward position until it engages the tapered surface 60 of each locking member segment 56 (FIG. 3A). Upon continued forward movement of the release sleeve 76 to its forward position, the release sleeve 76 interacts with and forces the locking member segments 56 to pivot clockwise (in the direction of arrow F) about the pivot axis P against the urging of the biasing element 74, thereby causing the biasing element 74 to expand radially outward. Each locking member segment 56 pivots clockwise until it reaches its releasing position (FIG. 3B). In this position, each locking member segment 56 is collapsed in the groove 46 to provide the necessary clearance to permit each locking member segment 56 to axially slide past the internal threads 24 of the first member 12. Accordingly, the second member 14 can be disconnected from the first member 12 resulting in the coupling assembly 10 being in the uncoupled position (FIG. 3C).

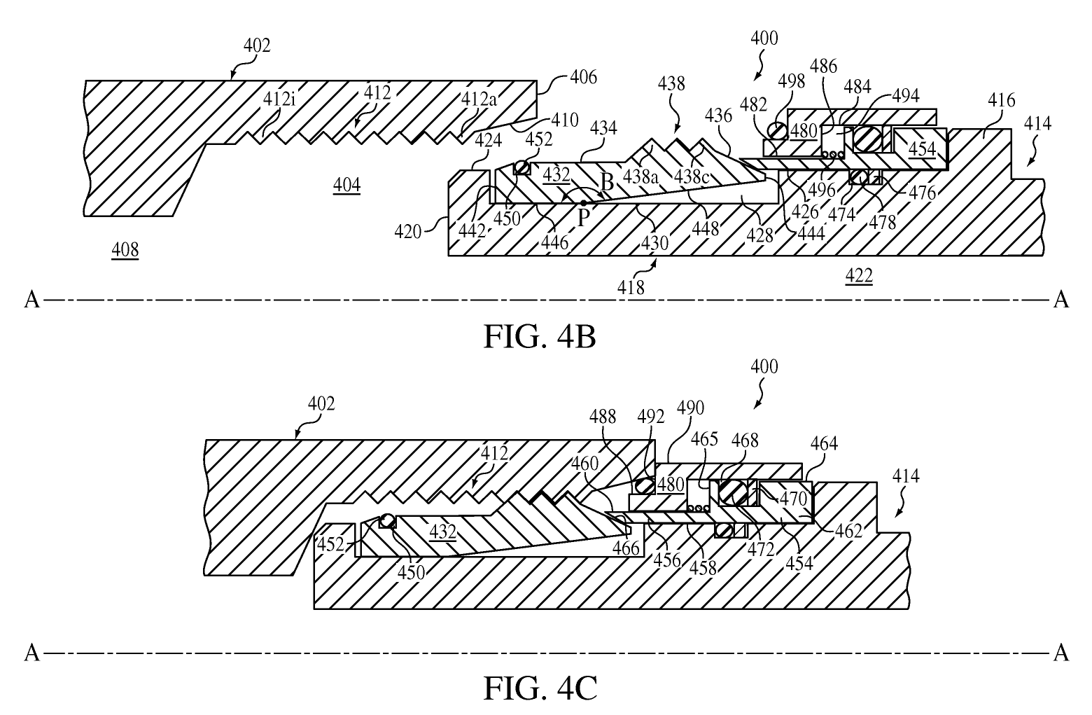

Illustrated in FIGS. 4A and 4B are perspective and cross-sectional views, respectively, of one embodiment of a male coupling 400 configured to be coupled to and separable from a female threaded coupling 402. Together, the male coupling 400 and the female threaded coupling 402 operate as a push-to-connect type coupling assembly, which will be discussed in further detail below. As shown in FIG. 4B, the male coupling 400 and the female threaded coupling 402 are in an uncoupled position. In the illustrated embodiment, the female threaded coupling 402 is a female threaded port, such as a standard female threaded port. In one embodiment, the standard female threaded port can be an SAE O-ring boss port. In alternative embodiments, the standard female threaded port can be ISO, DIN or BSPP O-ring ports.

Illustrated in FIG. 4C is a cross-sectional view of the male coupling 400 and the female threaded coupling 402 in a coupled position. In the coupled position, the male coupling 400 and the female threaded coupling 402 function as a coupling assembly to transmit fluid therethrough. Both the male coupling 400 and the female threaded coupling 402 share the same central longitudinal axis A when they are in the coupled position as shown in FIG. 4C. In one embodiment, the male coupling 400 and/or the female threaded coupling 402 can be formed of carbon steel. In alternative embodiments, the male coupling 400 and/or the female threaded coupling 402 can be formed of other materials, such as brass, aluminum, stainless steel, and plastic.

In the illustrated embodiment, the female threaded coupling 402 includes a receiving portion 404 having a receiving end 406 and a remote portion (not shown) having a remote end. Extending through the female threaded coupling 402 between the receiving end 406 and the remote end (not shown) is a passageway 408 that permits fluid to flow therethrough. In one embodiment (not shown), the remote portion of the female threaded coupling 402 can include external threads for attachment to internal threads of a separate component (not shown) or the female threaded port can be integrated into an apparatus, such as a pump, manifold, etc. In an alternative embodiment (not shown), the female threaded coupling 402 can include other suitable connection means for attachment to a separate component (not shown).

The female threaded coupling 402 also includes a chamfered surface 410 that extends rearward and inward from the receiving end 406. A set of internal threads 412 extend rearward from the chamfered surface 410. In the illustrated embodiment, the internal threads 412 have a triangular-shaped profile when viewed in cross-section and include nine threads 412a-i. In alternative embodiments (not shown), the internal threads 412 can take the form of other profiles (e.g., trapezoidal, square, or rectangular) when viewed in cross-section and include any number of threads. In another alternative embodiment (not shown), the female threaded coupling 402 may not include the chamfered surface 410.

In the illustrated embodiment, the male coupling 400 includes a body 414 having a collar 416 that separates a leading portion 418 having a leading end 420 and a trailing portion (not shown) having a trailing end (not shown). Extending through the body 414 from the leading end 420 to the trailing end (not shown) is a passageway 422 that permits fluid to flow therethrough. In one embodiment (not shown), the trailing portion of the body 414 can include or be connected to a hose nipple for receiving a hose. In alternative embodiments (not shown), the trailing portion may be provided with external threads for attachment to internal threads of another component or may be counter-bored for receiving a tube that can be brazed to the body 414.

The leading portion 418 of the body 414 includes a first exterior cylindrical surface 424 and a second exterior cylindrical surface 426 separated from each other by a first outwardly facing annular groove 428 that extends radially inward from the first and second exterior surfaces 424, 426. The first groove 428 is at least partially defined by a third exterior cylindrical surface 430.

As shown in FIGS. 4B and 4C, the first and second exterior surfaces 424, 426 have the same outer diameter that is sized to be received by the internal threads 412 of the female threaded coupling 402. In alternative embodiments (not shown), the first and second exterior surfaces 424, 426 may have different diameters, so long as the first exterior surface 424 has an outer diameter that is sized to be received by the internal threads 412 of the female threaded coupling 402.

The male coupling 400 also includes a ratcheting lock member to lock the male coupling 400 and the female threaded coupling 402 together. In the illustrated embodiment, the ratcheting locking member is in the form of four separate ratcheting, locking member segments 432 that are positioned within the groove 428 of the body 414 and, together, form the ratcheting locking member. In alternative embodiments (not shown), the ratcheting locking member can include a different number of locking member segments.

As shown in FIGS. 4B and 4C, each locking member segment 432 includes an exterior cylindrical surface 434 and an exterior tapered surface 436 that are separated from each other by a retaining formation that is configured to mesh with and engage the internal threads 412 of the female threaded coupling 402 when the male coupling 400 is inserted into the female threaded coupling 402, which is discussed in further detail below. In the illustrated embodiment, the retaining formation includes an external partial threaded formation 438. The partial threaded formation 438 projects outward from the groove 428 beyond the first exterior surface 424 of the body 414. The threaded formation 438 is characterized as being “partial” due to the fact that the ratcheting locking member is comprised of locking member segments 432. Hence, the partial threaded formation 438 of each locking member segment 432 comprises only a portion of a threaded formation. However, it will be appreciated that the locking member segments 432, together, form a threaded formation, although the threads may not be continuous since adjacent locking member segments 432 will have a small space in between them.

In the illustrated embodiment, the partial threaded formation 438 includes three triangular-shaped threads 438a-c when viewed in cross-section. However, in alternative embodiments (not shown), the partial threaded formation 438 can include a different number of threads and/or the threads can take the form of other shapes when viewed in cross-section (e.g., square, rectangular, or trapezoidal), so long as they are capable of meshing with and engaging the internal threads 412 of the female threaded coupling 402. Additionally, in alternative embodiments (not shown), the retaining formation can include a plurality of discrete radially outward extending projections or protrusions that are capable of engaging the internal threads 412 of the female threaded port 402. In these embodiments, the plurality of discrete radially outward extending projections or protrusions can take the form of any shape and can be arranged in any pattern, so long as they are capable of engaging the internal threads 412 of the female threaded port 402.

In the illustrated embodiment, each locking member segment 432 also includes a forward end 442, a rearward end 444, and first and second interior surfaces 446, 448. As shown in FIGS. 4B and 4C, the first and second interior surfaces 446, 448 are oriented at an angle B relative to each other, such that an edge is formed between the first interior surface 446 and the second interior surface 448. This edge defines a pivot axis P (extending out of the drawing) about which each locking member segment 432 pivots. The pivot axis P of each locking member segment 432 is spaced from and oriented perpendicular to the longitudinal axis A.

Due to the edge that defines the pivot axis P, each locking member segment 432 is capable of pivoting between a first position (i.e., a locking position) and a second position (i.e., a releasing position). In the locking position, the first interior surface 446 abuts against the third exterior surface 430 of the body as shown in FIGS. 4B and 4C. In the releasing position, each locking member segment 432 is pivoted about the pivot axis P in the clockwise direction, such that the second interior surface 448 abuts against the third exterior surface 430 (not shown). It will be appreciated, however, that the releasing position does not necessarily require that the second interior surface 448 of each locking member segment 432 abut against the third exterior surface 430. Instead, each locking member segment 432 need only pivot in the clockwise direction a sufficient amount to provide clearance between the outer extremities of the partial threaded formation 438 of the locking member segments 432 and the inner extremities of the internal threads 412 of the female threaded port 402.

Provided adjacent to the forward end 442 of each locking member segment 432 is an outwardly facing groove 450 extending radially inward from the exterior surface 434. Together, the grooves 450 in the locking member segments 432 form an annular groove configured to receive an annular biasing, resilient element 452. The biasing element 452, which wraps around all of the locking member segments 432, is configured to bias each locking member segment 432 radially inward to their locking positions and due to its resiliency, is capable of: i) expanding radially outwardly when the locking member segments 432 are moved to their releasing positions, and ii) returning the locking member segments 432 to their locking positions without the need of additional force. In the illustrated embodiment, the biasing element 452 is an O-ring. In alternative embodiments (not shown), the biasing element 460 can be a garter spring, a split retaining ring, or an elastomeric or plastic ring.

In an alternative embodiment (not shown), the locking member segments 432 may be rotated 180° and positioned within the groove 428 such that the retaining formation of the each locking member segment is located closer to the leading end 420 of the male coupling 400. In this embodiment, the biasing element would be provided in outwardly facing grooves in the locking member segments 432 adjacent the rearward end of the locking member segments 432.

The male coupling 400 also includes a release sleeve 454 provided between the locking member segments 432 and the collar 416. The release sleeve 454 includes a sleeve portion 456 having an interior cylindrical surface 458 and an exterior cylindrical surface 460, and a flange portion 462 that extends radially outward from the sleeve portion 456 and has an exterior cylindrical surface 464. The exterior surface 460 of the sleeve portion 456 and the exterior surface 464 of the shoulder portion 462 define a shoulder 465 therebetween. At its forward end, the sleeve portion 456 has a tapered end surface 466 that tapers rearward and towards the longitudinal axis A. In the illustrated embodiment, the release sleeve 454 has a generally L-shaped profile when viewed in cross-section. In alternative embodiments (not shown), the locking sleeve may take the form of other profiles when viewed in cross-section.

The release sleeve 454 is seated on the second exterior surface 426 of the body in an axially movable arrangement, such that the release sleeve 454 is movable between rearward and forward positions. Axial travel of the release sleeve 454 is limited in the rearward direction by the collar 416 and in the forward direction by the furthest rearward thread 438c of each locking member segment 432. The release sleeve 454 is in its rearward position as shown in FIGS. 4B and 4C.

The exterior surface 464 of the shoulder portion 462 of the release sleeve 454 includes an outwardly facing annular groove 468 extending radially inward therefrom. Positioned within the second groove 468 are a support ring 470 constructed of a rigid material, such as plastic, leather, or hard rubber, and an annular seal 472 constructed of a suitable sealing material, such as neoprene or another elastomeric material. The support ring 470 serves to protect the annular seal 472 from damage when the coupling assembly is used in high-pressure applications. In another embodiment (not shown), the support ring 470 may be eliminated when the male coupling 400 is used in low-pressure applications.

In the illustrated embodiment, the second exterior surface 426 of the body includes a second outwardly facing annular groove 474 extending radially inward therefrom. Positioned within the second groove 474 are a support ring 476 constructed of a rigid material, such as plastic, leather, or hard rubber, and an annular seal 478 constructed of a suitable sealing material, such as neoprene or another elastomeric material. The annular seal 478 sealingly engages the interior surface 458 of the release sleeve 454, thereby preventing dust or other contaminants from entering the area forward of the annular seal 478 and keeping the fluid pressure inside the male coupling 400 and the female threaded coupling 402. The support ring 476 is sized for receipt by the interior surface 458 of the release sleeve 454 and serves to protect the annular seal 478 from damage when the male coupling 400 is used in high-pressure applications. In an alternative embodiment (not shown), the support ring 476 may be eliminated when the male coupling 400 is used in low-pressure applications.

The male coupling 400 further includes a release sleeve insert 480 disposed about the release sleeve 454 in an axially movable arrangement relative thereto. The release sleeve insert 480 includes a first interior cylindrical surface 482 and a second interior cylindrical surface 484 that are separated from each other by a shoulder 486. The first interior surface 482 of the release sleeve insert 480 is sized to receive the sleeve portion 456 of the release sleeve 454.

As shown in FIGS. 4B and 4C, the second interior surface 484 has a greater diameter than the first interior surface 482. The second interior surface 484 is sized to receive and sealingly engage the annular seal 472 in the groove 468, thereby preventing dust or other contaminants from entering the area forward of the annular seal 472 and keeping the fluid pressure inside the male coupling 400 and the female threaded port 402. The second interior surface 484 is also sized to receive the support ring 470 in the groove 468.

The release sleeve insert 480 further includes a first exterior cylindrical surface 488 and a second exterior cylindrical surface 490 that are separated from each other by a shoulder 492. As shown in FIGS. 4B and 4C, the second exterior surface 490 has a greater diameter than the first exterior surface 488, while the first exterior surface 488 has a larger diameter than the second interior surface of the release sleeve insert 480.

In the illustrated embodiment, a gap 494 is provided between the shoulder 492 of the release sleeve insert 480 and the shoulder 465 of the release sleeve 454. Positioned within the gap 494 is a biasing element 496, such as a coil spring, configured to bias the release sleeve insert 480 forward. The biasing element 496 is particularly useful when the male coupling 400 is used in low-pressure applications. In an alternative embodiment (not shown), the biasing element 496 may be eliminated when the male coupling 400 is used in high-pressure applications. In alternative embodiments (not shown), the biasing element 496 may take the form of an annular elastomeric member (e.g., an O-ring), a cylindrical rubber sleeve, or a wave washer (also known as a spring washer).

The male coupling 400 further includes an annular seal 498 disposed about the first exterior surface 488 of the release sleeve insert 480. The annular seal 498 may be constructed of neoprene or other suitable sealing material and is configured to sealingly engage the chamfered surface 410 of the female threaded coupling 402. In the illustrated embodiment, the annular seal 498 has a smaller diameter than the annular seal 472.

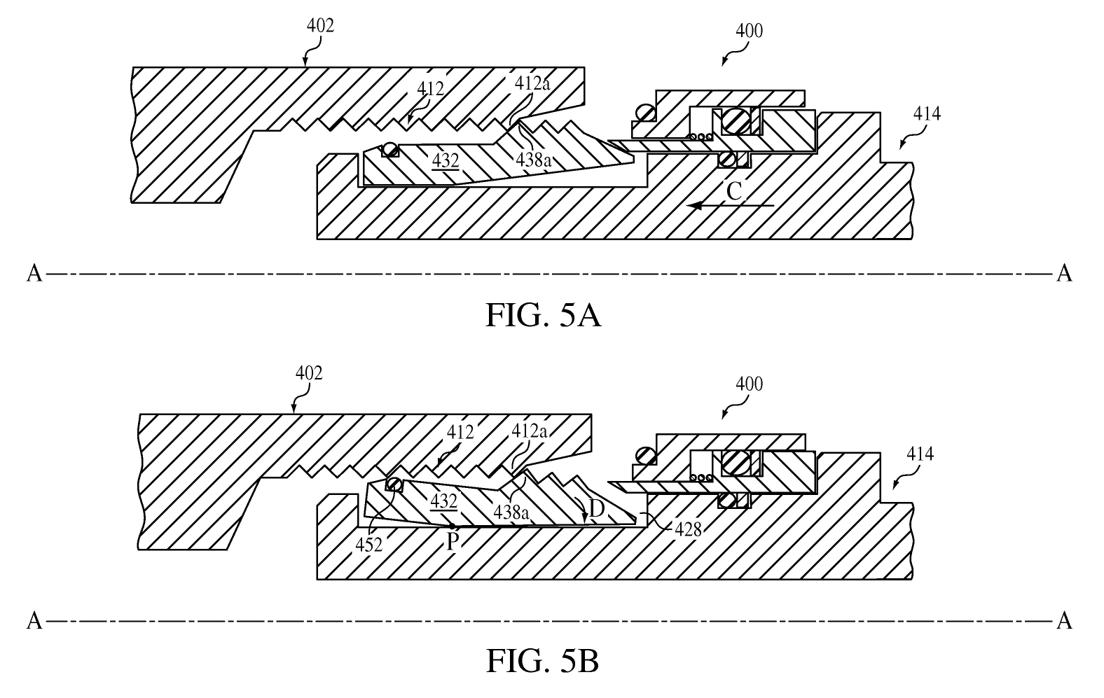

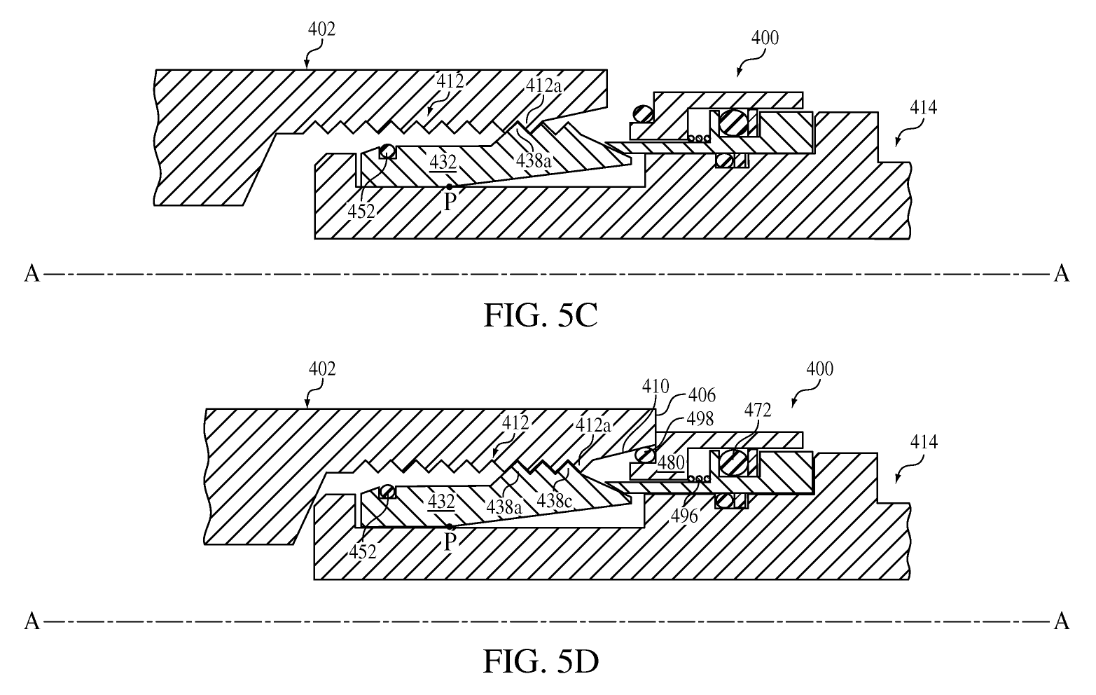

To couple the male coupling 400 to the female threaded coupling 402, the male coupling 400 is moved forward (in the direction of arrow C) into the female threaded coupling 402 until the forward most partial thread 438a of the partial threaded formation 438 of each locking member segment 432 engages the forward most thread 412a of the female threaded coupling 402 (FIG. 5A). Upon continued forward movement of the male coupling 400, the thread 412a of the female threaded coupling 402 interacts with and forces the locking member segments 432 to pivot clockwise (in the direction of arrow D) about the pivot axis P against the urging of the biasing element 452, thereby causing the biasing element 452 to expand radially outward (FIG. 5B). The locking member segments 432 pivot clockwise about the pivot axis P until they cam or “ratchet” over the apex of the thread 412a of the female threaded coupling 402. As soon as this occurs, the locking member segments 432 return or “spring back” to their locking position due to the resiliency of the biasing element 452, such that the partial thread 438a of the partial thread formation 438 meshes with and engages the internal thread 412a of the female threaded coupling 402 (FIG. 5C).

Upon further forward movement of the male coupling 400 into the female threaded coupling 402, the threaded formation 438 of each locking member segment 432 cams or “ratchets” along the internal threads 412 of the female threaded coupling 402, by alternating between locking and releasing positions, to progressively mesh with and engage additional internal threads 412 of the female threaded coupling 402 (i.e., the coupled position) (FIG. 5D). In this position, the engagement of the partial threaded formation 438 of the locking member segments 432 to the internal threads 412 of the female threaded coupling 402 prevents the withdrawal of the male coupling 400 from the female threaded coupling 402.

In low pressure applications, the annular seal 498 on the first exterior surface 488 of the release sleeve insert 480 is forced to sealingly engage the chamfered surface 410 of the female threaded coupling 402 by the biasing force of the biasing element 496 pressing against the shoulder 486 of the release sleeve insert 480. Accordingly, this sealing engagement between the male coupling 400 and the female threaded coupling 402 prevents fluid leakage therebetween. In high pressure applications, the annular seal 498 on the first exterior surface 488 of the release sleeve insert 480 is forced to sealingly engage the chamfered surface 410 of the female threaded coupling 402 upon pressurization of the male coupling 400 and the female threaded coupling 402. This is due to the biasing force of the biasing element 496 (if present) pressing against the shoulder 486 of the release sleeve insert 480 as well as the force applied to the shoulder 486 of the release sleeve insert 480 by the pressure imbalance created by the difference in diameters between the annular seal 498 (its outer diameter, whether in its neutral or compressed state) and the second interior surface 484 of the release sleeve insert 480 (i.e., the outer diameter of the annular seal 498 has a smaller diameter than the second interior surface 484 of the release sleeve insert 480 although this is not shown to scale in FIGS. 4B and 4C). The sealing engagement between the male coupling 400 and the female threaded coupling 402 also prevents fluid leakage therebetween.

Since the male coupling 400 is capable of connecting to a female threaded coupling, such as a standard female threaded port, a female adapter can be eliminated reducing cost as well as a leak path. Additionally, customers would no longer be required to purchase all of their replacement hoses from the manufacturer of the coupling assembly.

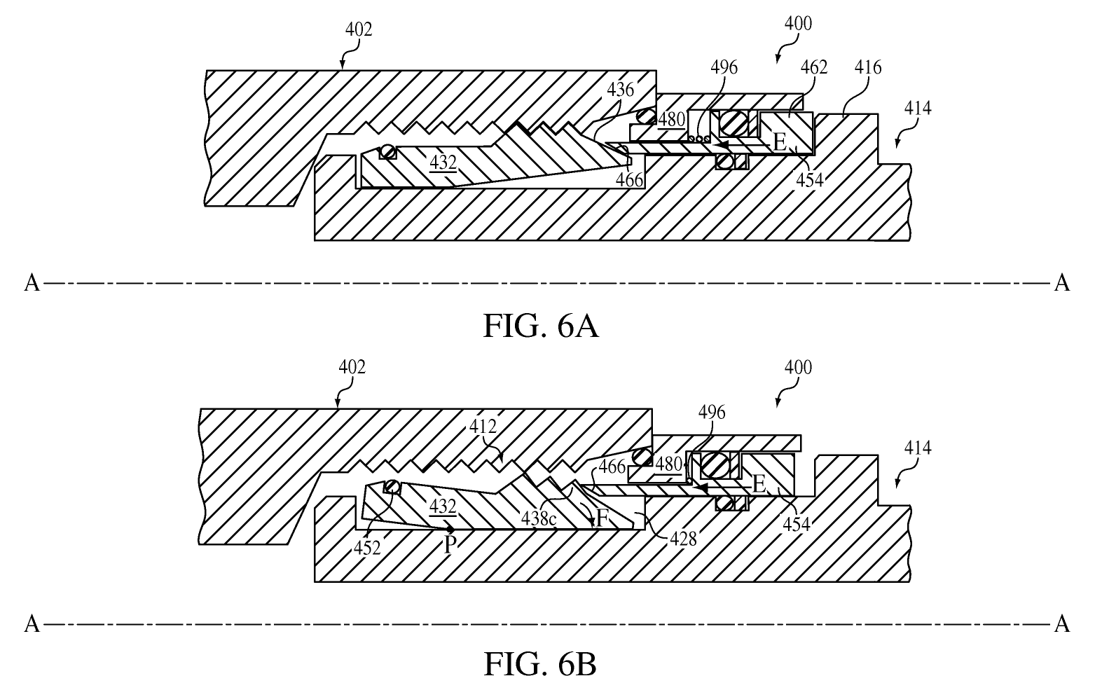

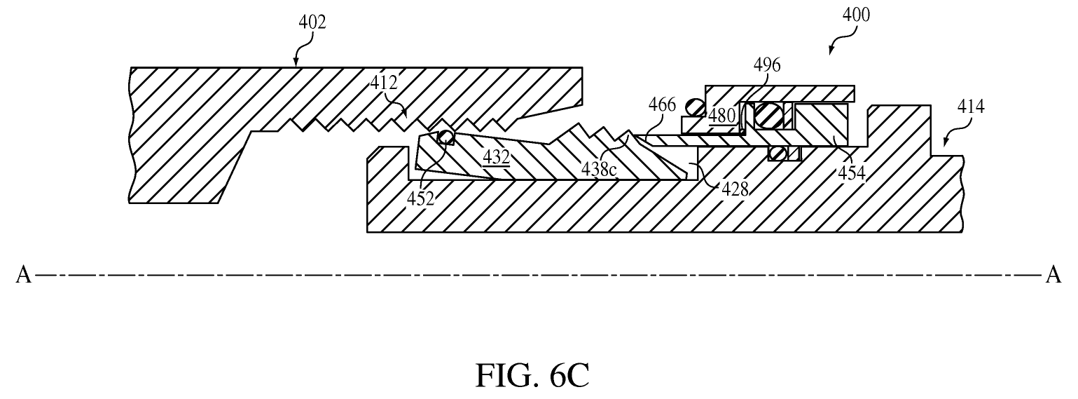

When it is desired to uncouple the male coupling 400 from the female threaded coupling 402, the release sleeve 454 is moved forward (in the direction of arrow E) against the urging of the biasing element 496 until it engages the tapered surface 466 of each locking member segment 432 (FIG. 6A). To facilitate the movement of the release sleeve 462 from its rearward position to its forward position, a tool may be used for additional leverage between the shoulder portion 462 of the release sleeve 454 and the collar 416 to assist in moving the release sleeve 454 forward against the biasing force of the biasing element 496.

Upon continued forward movement of the release sleeve 454 from its rearward position to its forward position, the release sleeve 454 interacts with and forces the locking member segments 432 to pivot clockwise (in the direction of arrow F) about the pivot axis P against the urging of the biasing element 452, thereby causing the biasing element 452 to expand radially outward. Each locking member segment 432 pivots clockwise until it reaches its releasing position (FIG. 6B). In this position, each locking member segment 432 is collapsed in the groove 428 and provides the necessary clearance to permit the male coupling 400 to axially slide past the internal threads 412 of the female threaded coupling 402. Accordingly, the male coupling 400 can be disconnected from the female threaded coupling 402 resulting in the two components being in the uncoupled position (FIG. 6C).

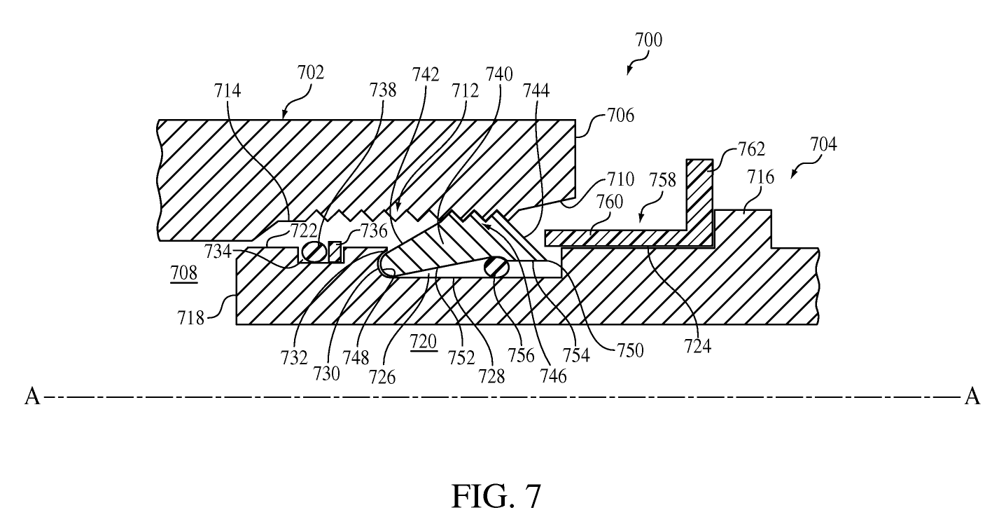

Illustrated in FIG. 7 is a cross-sectional view of another embodiment of a coupling assembly 700 shown in its coupled position. The coupling assembly 700 includes a first member 702 and a second member 704 that, together, operate as a push-to-connect type coupling assembly. The first member 702 generally functions as the “female” member of the coupling assembly 700 and the second member 704 generally functions as the “male” member of the coupling assembly 700, such that the first member 702 is configured to receive the second member 704. Both the first and second members 702, 704 share the same central longitudinal axis A when they are in the coupled position as shown in FIG. 7.

In the illustrated embodiment, the first member 702 is a female threaded coupling, such as a female threaded port that is substantially similar to the first member 12 described above and illustrated in FIGS. 1A and 1B. Like the first member 12, the first member 702 includes a receiving portion having a receiving end 706 and a remote portion (not shown) having a remote end (not shown). Extending through the first member 702 between the receiving end 706 and the remote end (not shown) is a passageway 708 that permits fluid to flow therethrough.

With continued reference to FIG. 7, the first member 702 includes a first chamfered surface 710 that extends rearward and inward from the receiving end 708. A set of internal threads 712 extends rearward from the first chamfered surface 710 and a first interior cylindrical surface 714 extends rearward from the internal threads 712a-i. In the illustrated embodiment, the internal threads 712 have a triangular-shaped profile when viewed in cross-section and include nine threads 712a-i. In alternative embodiments (not shown), the internal threads 712 can take the form of other profiles (e.g., trapezoidal, square, or rectangular) when viewed in cross-section and include any number of threads. In another alternative embodiment (not shown), the first member 702 may not include the chamfered surface 710.

In the illustrated embodiment, the second member 704 is similar to the second member 14 described above and illustrated in FIGS. 1A and 1B. Specifically, the second member 704 includes a collar 716 that separates a leading portion having a leading end 718 from a trailing portion (not shown) having a trailing end (not shown). Extending through the second member 704 from the leading end 718 to the trailing end (not shown) is a passageway 720 that permits fluid to flow therethrough.

The leading portion of the second member 704 includes a first exterior cylindrical surface 722 and a second exterior cylindrical surface 724 separated from each other by a first outwardly facing annular groove 726 that extends radially inward from the first and second exterior surfaces 716, 718. The first groove 726 is at least partially defined by a third exterior cylindrical surface 728 and a radially extending concave surface 730 that joins the first and third exterior surfaces 722, 728 together. The concave surface 730 forms a lip 732 that extends axially into a portion of the first groove 726.

In the illustrated embodiment, the first exterior surface 722 of the second member 704 includes a second outwardly facing annular groove 734 extending radially inward therefrom. Positioned within the second groove 734 are a support ring 736 constructed of a rigid material, such as plastic, leather, or hard rubber, and an annular seal 738 constructed of a suitable sealing material, such as neoprene or another elastomeric material. The annular seal 738 is positioned in the second groove 734 between the support ring 736 and the leading end 718 of the second member 704.

The coupling assembly 700 also includes a ratcheting locking member configured to lock the first and second members 702, 704 together. In the illustrated embodiment, the ratcheting locking member is in the form of separate ratcheting, locking member segments 740 that are positioned within the first groove 726 and, together, form the ratcheting locking member. In one embodiment, the ratcheting locking member includes four locking member segments 740. In alternative embodiments, the ratcheting locking member can include a different number of locking member segments.

As shown in FIG. 7, each locking member segment 740 includes a first exterior surface 742 and a second exterior surface 744 that are separated from each other by a retaining formation that is configured to mesh with and engage the internal threads 712 of the first member 702 when the second member 704 is inserted into the first member 702, which is discussed in further detail below. In the illustrated embodiment, the retaining formation includes an external partial threaded formation 746 that projects outward from the first groove 726 beyond the first exterior surface 722.

In the illustrated embodiment, the partial threaded formation 746 includes three triangular-shaped threads when viewed in cross-section. However, in alternative embodiments (not shown), the partial threaded formation 746 can include a different number of threads and/or the threads can take the form of other shapes when viewed in cross-section (e.g., square, rectangular, or trapezoidal), so long as they are capable of meshing with and engaging the internal threads 712 of the first member 702. Additionally, in alternative embodiments (not shown), the retaining formation can include a plurality of discrete radially outward extending projections or protrusions that are capable of engaging the internal threads 712 of the first member 702. In these embodiments, the plurality of discrete radially outward extending projections or protrusions can take the form of any shape and can be arranged in any pattern, so long as they are capable of engaging the internal threads 712 of the first member 702.

Each locking member segment 740 also includes a curved forward end 748, a rearward end 750, and first and second converging interior surfaces 752, 754 that form a recess between them. The curved forward end 748 of each locking member segment 738 is seated in the concave surface 730 of the second member 704, permitting each locking member segment 740 to pivot relative to the second member 704 between a locking position (as shown in FIG. 7) and a releasing position (not shown).

Disposed between the locking member segments 740 and the third exterior surface 728 of the second member 704 is a resilient compressible member 756, such as an O-ring or garter spring. The resilient compressible member 756 is configured to bias the locking member segments 740 to their locking positions and is capable of: i) compressing radially inwardly due to its compressibility when the locking member segments 740 are moved to their releasing positions and ii) returning the locking member segments 740 to their locking positions without the need of additional force due to its resiliency. It will be appreciated that the arrangement of the locking member segments 740 and the resilient compressible member 756 described above can be used in the male coupling 400 described above and illustrated in FIGS. 4A-4C.

In an alternative embodiment (not shown), the locking member segments 740 may be rotated 180° and positioned within the first groove 726 such that the retaining formation of the each locking member segment is located closer to the leading end 718 of the second member 704. In this embodiment, the biasing element would be provided in outwardly facing grooves in the locking member segments 740 adjacent the rearward end of the locking member segments 740.

The coupling assembly 700 also includes a release sleeve 758 provided between the locking member segments 740 and the collar 716. The release sleeve 758 includes a sleeve portion 760 and a flange portion 762 that extends radially outward from the sleeve portion 760. The sleeve portion 760 of the release sleeve 758 overlaps a portion of the first groove 726 and a portion of the rearward end 750 of the locking member segments 740. Thus, the locking member segments 740 are retained in the first groove 726 by the lip 732 of the second member 704 and by the sleeve portion 760 of the release sleeve 758.

The release sleeve 758 is seated on the second exterior surface 724 of the body in an axially movable arrangement, such that it is movable between rearward and forward positions. Axial travel of the release sleeve 758 is limited in the rearward direction by the collar 716 and in the forward direction by the furthest rearward partial thread 746 of each locking member segment 740. The release sleeve 758 is in its rearward position as shown in FIG. 7.

The coupling operation of the coupling assembly 700 is similar to the coupling operation described above and illustrated in FIGS. 2A-2D. Additionally, the uncoupling operation of the coupling assembly 700 is similar to the uncoupling operation described above and illustrated in FIGS. 3A-3C.

For all of the embodiments discussed above, it will be appreciated that one or more of the cylindrical surfaces discussed above may be replaced with a surface having a linear profile that is angled relative to the longitudinal axis A of the coupling assembly (e.g., tapered surfaces) or a curved surface (e.g., convex or concave surfaces). Additionally, it will be appreciated that one or more of the tapered or chamfered surfaces discussed above may be replaced with a cylindrical surface relative to the longitudinal axis A of the coupling assembly (e.g., tapered surfaces) or a curved surface (e.g., convex or concave surfaces)

It will be appreciated that the male couplings described above have applicability in areas other than fluid connectors. For example, a device that includes one of the male couplings described above, particularly the ratcheting locking member and the release sleeve, can be used as a push-to-connect type fastening device that connects to a female thread in a separate device. In this example, the components need not transport fluid.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components.

While the present application illustrates various embodiments, and while these embodiments have been described in some detail, it is not the intention of the applicant to restrict or in any way limit the scope of the claimed invention to such detail. Additional advantages and modifications will readily appear to those skilled in the art. Therefore, the invention, in its broader aspects, is not limited to the specific details and illustrative examples shown and described. Accordingly, departures may be made from such details without departing from the spirit or scope of the applicant's claimed invention. Moreover, the foregoing embodiments are illustrative, and no single feature or element is essential to all possible combinations that may be claimed in this or a later application.

What is claimed is:

1. A coupling assembly comprising:
first and second members arrangeable between uncoupled and coupled positions, the first member having a receiving portion sized to receive at least a portion of the second member and having internal threads provided therein, the second member having an exterior surface; and
a ratcheting locking member disposed about the exterior surface of the second member and configured to move between locking and releasing positions, the ratcheting locking member biased to its locking position and having a retaining formation configured to mesh with and engage the internal threads of the first member;
wherein, upon insertion of the second member into the first member, the retaining formation of the ratcheting locking member progressively engages the internal threads of the first member, thereby locking the first and second members together.

2. The coupling assembly of claim 1, wherein the ratcheting locking member includes a number of locking member segments.

3. The coupling assembly of claim 2, wherein the second member includes an outwardly facing groove extending inwardly from the exterior surface that is sized to receive the locking member segments.

4. The coupling assembly of claim 1, wherein the retaining formation includes a partial threaded formation.

5. The coupling assembly of claim 1, further comprising a resilient biasing element configured to bias the ratcheting locking member to its locking position.

6. The coupling assembly of claim 5, wherein the biasing element includes at least one of, an O-ring, garter spring, or split retaining ring.

7. The coupling assembly of claim 5, wherein the biasing element is disposed between the ratcheting locking member and the second member.

8. The coupling assembly of claim 1, further comprising a release sleeve configured to move the ratcheting locking member to its releasing position to permit withdrawal of the second member from the first member.

9. The coupling assembly of claim 1, further comprising an annular seal between the first and second members when the second member is fully inserted into the first member.

10. A male coupling for connecting to a female threaded port having a receiving portion provided with internal threads, the male coupling comprising:
a body having a leading portion, a trailing portion, and an exterior surface, the leading portion sized to be received by the receiving portion of the female threaded portion;
a number of locking member segments disposed about the body and configured to pivot between locking and releasing positions, each locking member segment having a retaining formation configured to mesh with and engage the internal threads of the female threaded port; and
a resilient biasing element configured to bias each locking member segment to its locking position,
wherein, upon insertion of the male coupling into the female threaded port, the retaining formation of each locking member segment progressively engages the internal threads of the female threaded port, thereby locking the male coupling and the female threaded port together.

11. The male coupling of claim 10, wherein the female threaded port includes a standard female threaded port.

12. The male coupling of claim 10, wherein the retaining formation includes a partial threaded formation.

13. The male coupling of claim 10, wherein the biasing element includes at least one of, an O-ring, garter spring, or split retaining ring.

14. The male coupling of claim 13, wherein the biasing element is positioned in an outwardly facing groove extending inwardly from an exterior surface of each locking member segment.

15. The male coupling of claim 13, wherein the biasing element is disposed between the locking member segments and the body.

16. The male coupling of claim 10, further comprising an annular seal between the male coupling and the female threaded port when the male coupling is fully inserted into the female threaded port.

17. The male coupling of claim 10, further comprising a release sleeve configured to move the locking member segments to their respective releasing positions to permit withdrawal of the male coupling from the female threaded port.

18. The male coupling of claim 17, further comprising an annular seal between the body and the release sleeve.

19. The male coupling of claim 17, further comprising a release sleeve insert disposed about the release sleeve and biased in the forward direction.

20. The male coupling of claim 19, further comprising an annular seal between the release sleeve and the release sleeve insert.

21. The male coupling of claim 20, further comprising a biasing element disposed between the release sleeve insert and the release sleeve to bias the release sleeve in the forward direction.

22. The male coupling of claim 21, wherein the biasing element includes at least one of, a wave washer, O-ring, cylindrical rubber sleeve, or coil spring.

23. The male coupling of claim 10, further comprising an annular seal provided on the release sleeve insert and configured to seal against a surface of the female threaded port when the male coupling is fully inserted into the female threaded port.

24. A male coupling for connecting to a female threaded port having a receiving portion provided with internal threads, the male coupling comprising:
a body having a leading portion, a trailing portion, an exterior surface, and an outwardly facing groove extending inwardly from the exterior surface, the leading portion sized to be received by the receiving portion of the female threaded portion;
a plurality of locking member segments arranged in the groove of the body and configured to pivot between locking and releasing positions, each locking member segment having a partial threaded formation configured to mesh with and engage the internal threads of the female threaded port; and
a resilient biasing element configured to bias each locking member segment to its locking position,
wherein, upon insertion of the male coupling into the female threaded port, each locking member segment is forced to pivot against the urging of the biasing element from its locking position to its releasing position,
wherein, upon continued insertion of the male coupling into the female threaded port, each locking member segment returns to its locking position due to the resiliency of the biasing element, such that one of the partial threads of the partial threaded formation of the locking member segment meshes with and engages one of the threads of the internal threads in the female threaded port,
wherein, upon further insertion of the male coupling into the female threaded port, the locking member segments alternate between releasing and locking positions, such that the remaining partial threads of the partial threaded formation of the locking member segments progressively mesh with and engage additional internal threads in the female threaded port, thereby locking the male coupling and the female threaded port together

25. The male coupling of claim 24, wherein the biasing element includes at least one of, an O-ring, garter spring, or split retaining ring.

26. The male coupling of claim 24, further comprising an annular seal between the male coupling and the female threaded port when the male coupling is fully inserted into the female threaded port.
